(19) United States
(12) Patent Application Publication
(10) Pub. No.: US 2026/0369933 A1
(43) Pub. Date: Nov. 19, 2026

(54) ELECTRICAL CONNECTOR

(71) Applicant: CHENG UEI PRECISION INDUSTRY CO., LTD., New Taipei City (TW)

(72) Inventors: YU-HUNG SU, New Taipei City (TW); SHENG-YUAN HUANG, New Taipei City (TW); PEI-YI LIN, New Taipei City (TW)

(21) Appl. No.: 19/329,528

(22) Filed: Sep. 15, 2025

(30) Foreign Application Priority Data
May 13, 2025 (CN) 202520939570.0

(51) Int. Cl. H01R 13/6461; H01R 12/70; H01R 13/436; H01R 13/508

(52) U.S. Cl. CPC H01R 13/6461; H01R 12/707; H01R 13/436; H01R 13/508

(57) ABSTRACT

An electrical connector includes a first insulating holder shown as a narrow rectangular shape, a first terminal module penetrating through the first insulating holder along an up-down direction, a second insulating holder shown as the narrow rectangular shape, a second terminal module and a conductive connecting element. The second insulating holder is combined with the first insulating holder. The second terminal module penetrates through the second insulating holder along the up-down direction. The conductive connecting element is fully surrounded between the first insulating holder and the second insulating holder.

### CROSS REFERENCE TO RELATED APPLICATIONS

The present application is based on, and claims priority from, China Patent Application No. 202520939570.0, filed May 13, 2025, the disclosure of which is hereby incorporated by reference herein in its entirety.

### BACKGROUND OF THE INVENTION

### Field of the Invention

The present invention generally relates to an electrical connector, and more particularly to an electrical connector capable of stably working in a high-frequency environment.

### DESCRIPTION OF RELATED ART

In recent years, electronic industries are developed prosperously, and consumers tend to select electronic products which are lighter, thinner, shorter, smaller and more portable so as to propel miniaturized electronic products to become a market mainstream. Because of the above-mentioned causes, sizes of the electronic products develop towards a miniaturized direction. Circuit boards and connectors of the electronic products are pulled to be miniaturized correspondingly, especially, the sizes of the connectors applied in internal wirings, such as board-to-board connectors, chip-to-chip connectors and chip-to-board connectors are miniaturized. A distance among terminals of an internal terminal assembly of the connector is overly close, in that case, when high-frequency signals are transmitted, a crosstalk problem is intensified. Consequently, the connector has no way of stably working in a high-frequency environment.

Thus, it is essential to provide an innovative electrical connector, and the innovative electrical connector is capable of stably working in a high-frequency environment.

### BRIEF SUMMARY OF THE INVENTION

An object of the present invention is to provide an electrical connector capable of stably working in a high-frequency environment. The electrical connector includes a first insulating holder shown as a narrow rectangular shape, a first terminal module penetrating through the first insulating holder along an up-down direction, a second insulating holder shown as the narrow rectangular shape, a second terminal module and a conductive connecting element. The first terminal module includes a plurality of signal terminals and a plurality of grounding terminals. Each two adjacent signal terminals are located between two grounding terminals. The second insulating holder is matched with the first insulating holder. The second insulating holder is combined with the first insulating holder. The second terminal module penetrates through the second insulating holder along the up-down direction. The second terminal module includes the plurality of the signal terminals and the plurality of the grounding terminals. The plurality of the grounding terminals of the first terminal module and the plurality of the grounding terminals of the second terminal module are symmetrically disposed along a longitudinal direction. The conductive connecting element is fully surrounded between the first insulating holder and the second insulating holder. The conductive connecting element is electrically connected between the first terminal module and the second terminal module. The conductive connecting element has a main portion, and a plurality of connecting blocks longitudinally protruded outward from the main portion. The main portion is shown as a lathy shape. The main portion is clamped between the first insulating holder and the second insulating holder. The plurality of the connecting blocks are continuously disposed along the main portion. The plurality of the connecting blocks are arranged at fixed intervals. The plurality of the connecting blocks are extended outward, and the plurality of the connecting blocks are electrically connected with the plurality of the grounding terminals of the first terminal module and the second terminal module.

Another object of the present invention is to provide an electrical connector. The electrical connector includes a shell, an insulating body disposed in the shell, a terminal holder assembly fastened in the insulating body, a terminal module and a conductive connecting element. The terminal module is fastened in the terminal holder assembly. The terminal module includes a plurality of grounding terminals, and a plurality of signal terminals disposed among the plurality of the grounding terminals. Each signal terminal has a fastening portion fastened in the terminal holder assembly. Each grounding terminal has a fixing portion fixed in the terminal holder assembly. A top end of the fastening portion extends upward to form a contacting portion. A top end of the fixing portion extends upward to form a touching portion. A bottom end of the fastening portion is bent outward to form a soldering portion. A bottom end of the fixing portion is bent outward to form a soldering bar. One side of the fastening portion of each signal terminal which is adjacent to the fixing portion of one grounding terminal is recessed inward to form a lacking groove. A position of the fixing portion of each grounding terminal which is corresponding to the lacking groove of one signal terminal forms a narrowing portion. Two opposite sides of the narrowing portion are recessed inward. The conductive connecting element is completely surrounded by the terminal holder assembly. The conductive connecting element has a main portion, and a plurality of connecting blocks longitudinally protruded outward from the main portion. Each connecting block has two opposite outer surfaces facing towards two grounding terminals. Each outer surface of each connecting block protrudes outward to form at least one protruding point. The at least one protruding point is electrically connected with the narrowing portion of the one grounding terminal.

Another object of the present invention is to provide an electrical connector. The electrical connector includes a shell, an insulating body disposed in the shell, a terminal holder assembly, a terminal module, a conductive connecting element. The insulating body has a receiving groove formed inside the insulating body and penetrating through a bottom of the insulating body, two inner surfaces disposed to two opposite sides of the receiving groove, two base portions protruded inward from the two inner surfaces, two arm portions extended downward from bottom surfaces of the two base portions, two hooking portions protruded inward from two bottom ends of the two arm portions, and two avoiding spaces. Each avoiding space is formed between one arm portion and one inner surface. The terminal holder assembly is received in the receiving groove. The terminal holder assembly has two short side walls disposed at two opposite sides of the terminal holder assembly, and two holding slots recessed inward in two middles of two outer surfaces of the two short side walls. The terminal module is fastened in the terminal holder assembly. The terminal module includes a plurality of grounding terminals, and a plurality of signal terminals disposed among the plurality of the grounding terminals. Each signal terminal has a fastening portion fastened in the terminal holder assembly. Each grounding terminal has a fixing portion fixed in the terminal holder assembly. A top end of the fastening portion extends upward to form a contacting portion. A top end of the fixing portion extends upward to form a touching portion. A bottom end of the fastening portion is bent outward to form a soldering portion. A bottom end of the fixing portion is bent outward to form a soldering bar. The conductive connecting element is disposed in the terminal holder assembly. The conductive connecting element is electrically connected with the fixing portion of each grounding terminal. The two arm portions are received in the two holding slots. The two hooking portions hook a bottom surface of the terminal holder assembly.

As described above, the conductive connecting element is electrically connected with the plurality of the grounding terminals of the first terminal module and the second terminal module, so a potential difference among the plurality of the grounding terminals of the first terminal module and the second terminal module is eliminated, a resonance point of a crosstalk is pushed to a high frequency. Furthermore, the contacting portions of the plurality of the signal terminals and the touching portions of the plurality of the grounding terminals taper from bottom to top, each signal terminal has the lacking groove, and each grounding terminal has the narrowing portion, a section area of each signal terminal and a section area of each grounding terminal are reduced, and an impedance of each signal terminal and an impedance of each grounding terminal are decreased. As a result, the electrical connector effectively restrains the resonance point of the crosstalk, a crosstalk problem of high-frequency signals is improved, and a transmission capability of the high-frequency signals is improved.

### BRIEF DESCRIPTION OF THE DRAWINGS

The present invention will be apparent to those skilled in the art by reading the following description, with reference to the attached drawings, in which:

FIG. 1 is a perspective view of an electrical connector according to the present invention;

FIG. 2 is an exploded view of the electrical connector;

FIG. 3 is an enlarged view of an encircled portion X of the electrical connector of FIG. 2;

FIG. 4 is an exploded view of a terminal assembly of the electrical connector of FIG. 2;

FIG. 5 is an exploded view of a terminal holder assembly of the electrical connector of FIG. 2;

FIG. 6 is a partial top view of a terminal module according to the present invention;

FIG. 7 is a partial top view of the terminal assembly according to the present invention;

FIG. 8 is a vertical view of the terminal assembly according to the present invention;

FIG. 9 is a sectional view of the terminal assembly along a line A-A of FIG. 8;

FIG. 10 is a sectional view of the terminal assembly along a line B-B of FIG. 8; and

FIG. 11 is an enlarged view of an encircled portion Y of the terminal assembly of FIG. 10.

### DETAILED DESCRIPTION OF THE INVENTION

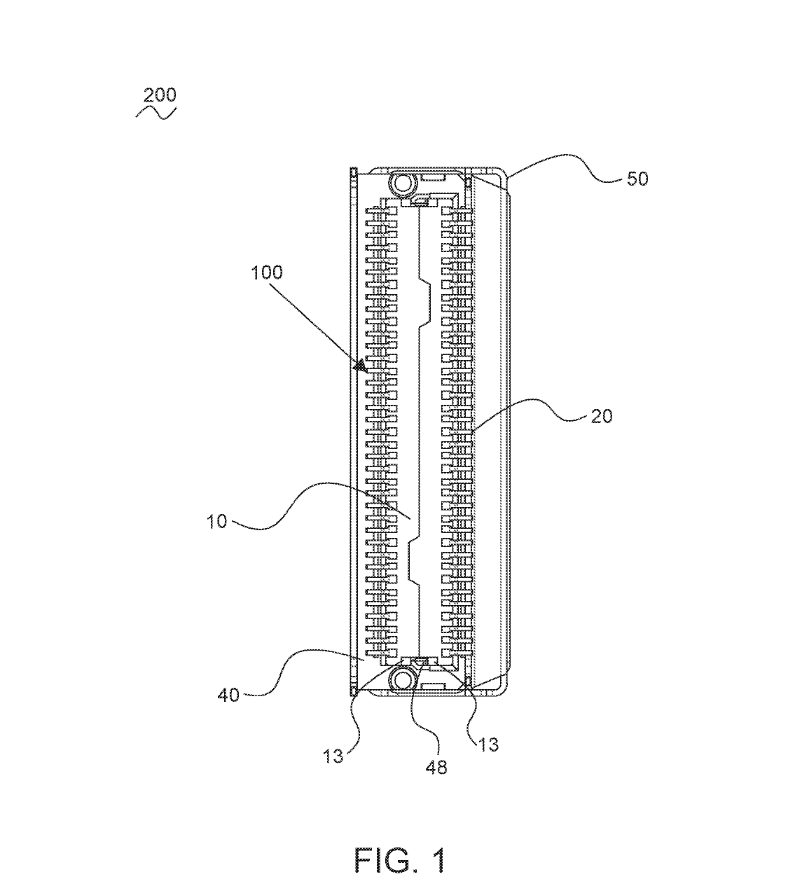

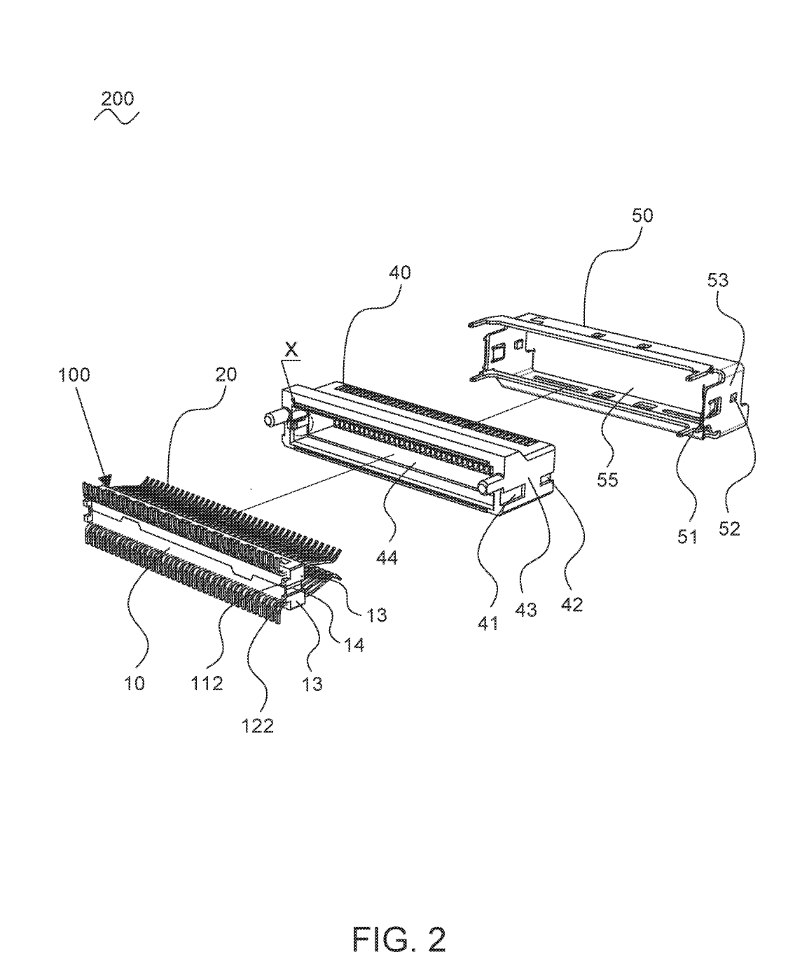

With reference to FIGS. 1 and 2, an electrical connector 200 according to a preferred embodiment of the present invention is shown. The electrical connector 200 includes a shell 50, an accommodating space 55 formed inside the shell 50, an insulating body 40 disposed in the accommodating space 55 of the shell 50, a terminal assembly 100 mounted in the insulating body 40. The accommodating space 55 penetrates through a middle of the shell 50 along an up-down direction.

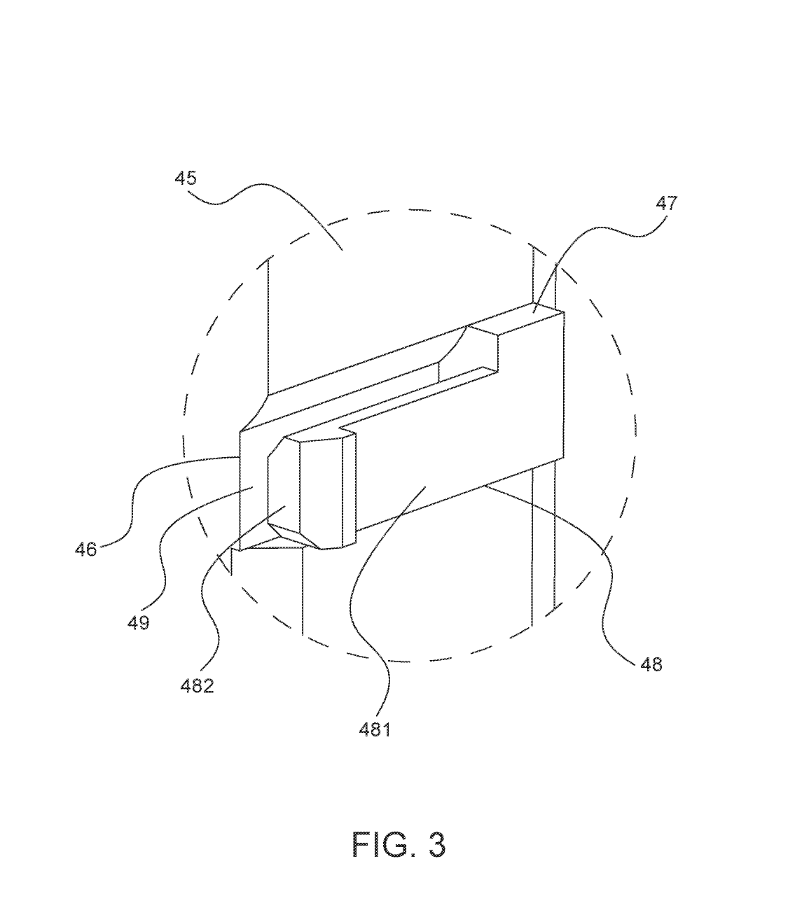

Referring to FIGS. 2-4, the terminal assembly 100 includes a terminal holder assembly 10, and a terminal module 20 fastened in the terminal holder assembly 10. The terminal holder assembly 10 is fastened in the insulating body 40. The terminal holder assembly 10 includes a first insulating holder 11, a second insulating holder 12 matched with the first insulating holder 11, and a conductive connecting element 30. The second insulating holder 12 is assembled with the first insulating holder 11. The conductive connecting element 30 is clamped between the first insulating holder 11 and the second insulating holder 12. The conductive connecting element 30 is disposed in the terminal holder assembly 10. The conductive connecting element 30 is fully surrounded between the first insulating holder 11 and the second insulating holder 12. The terminal module 20 includes a first terminal module 21 and a second terminal module 22. The first terminal module 21 penetrates through the first insulating holder 11 along the up-down direction. The second terminal module 22 penetrates through the second insulating holder 12 along the up-down direction.

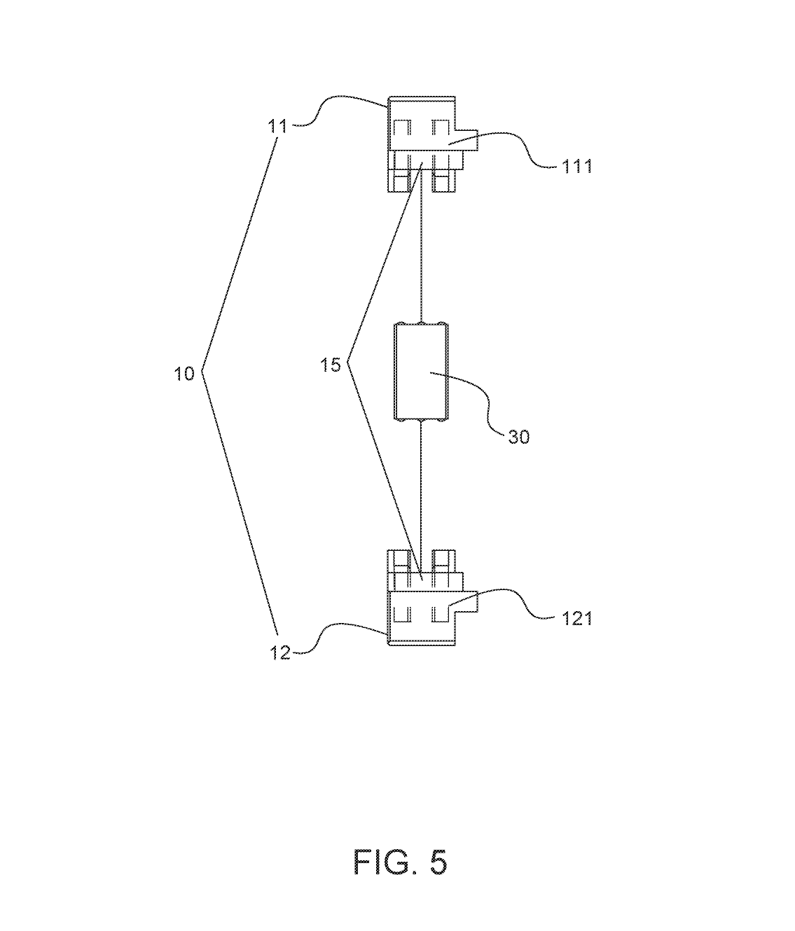

Referring to FIGS. 2-5, the terminal holder assembly 10 is shown as a rectangular shape. The first insulating holder 11 is shown as a narrow rectangular shape. The second insulating holder 12 is shown as the narrow rectangular shape. The second insulating holder 12 is matched with the first insulating holder 11. The second insulating holder 12 is combined with the first insulating holder 11. A middle of an inner surface of the first insulating holder 11 is recessed inward to form a first recess 111, and a middle of an inner surface of the second insulating holder 12 is recessed inward to form a second recess 121. The inner surface of the first insulating holder 11 is combined with the inner surface of the second insulating holder 12, so the first recess 111 is combined with the second recess 121 to define a fastening space 15. The conductive connecting element 30 is disposed in the fastening space 15. The conductive connecting element 30 is fastened in the fastening space 15.

The shell 50 has two opposite short lateral walls 53. Each short lateral wall 53 has a first buckling portion 51 and a second buckling portion 52. A lower portion of each short lateral wall 53 is punched inward to form the first buckling portion 51. An upper portion of each short lateral wall 53 is punched inward to form the second buckling portion 52. The first buckling portion 51 is disposed under the second buckling portion 52. The insulating body 40 has two opposite short side surfaces 43. Two opposite outer side surfaces of the insulating body 40 are defined as the two opposite short side surfaces 43. Each short side surface 43 has a first buckling groove 41 and a second buckling groove 42. A bottom of each short side surface 43 is recessed inward to form the first buckling groove 41. A top of each short side surface 43 is recessed inward to form the second buckling groove 42. The first buckling groove 41 is located under the second buckling groove 42. The shell 50 is mounted around an outside of the insulating body 40. The first buckling portion 51 is buckled in the first buckling groove 41. The second buckling portion 52 is buckled in the second buckling groove 42.

The insulating body 40 has a receiving groove 44 formed inside the insulating body 40 and penetrating through a bottom of the insulating body 40. Two opposite sides of the inside of the insulating body 40 have respectively two opposite inner surfaces 45. The two inner surfaces 45 are disposed to two opposite sides of the receiving groove 44. The two inner surfaces 45 are opposite to the two short side surfaces 43. A middle of each inner surface 45 is recessed outward to form a concave surface 46. A top of the concave surface 46 protrudes inward to form a base portion 47. The base portion 47 extends out of the concave surface 46. Two base portions 47 are protruded inward from the two inner surfaces 45. The base portion 47 projects beyond the inner surface 45.

A bottom surface of the base portion 47 extends downward to form a locking portion 48. The locking portion 48 is spaced from the concave surface 46 to form an avoiding space 49 between the locking portion 48 and the concave surface 46. When the locking portion 48 is elastically deformed, the avoiding space 49 provides a moving space for the locking portion 48. The locking portion 48 has an arm portion 481 and a hooking portion 482. The arm portion 481 is extended downward from the bottom surface of the base portion 47. The hooking portion 482 is protruded inward from a bottom end of the arm portion 481. Two arm portions 481 are extended downward from the bottom surfaces of the two base portions 47. Two hooking portions 482 are protruded inward from two bottom ends of the two arm portions 481. The insulating body 40 has two avoiding spaces 49. The concave surface 46 of each inner surface 45 is spaced from one arm portion 481 to form the avoiding space 49 between the concave surface 46 of each inner surface 45 and the one arm portion 481. Each avoiding space 49 is formed between one arm portion 481 and one inner surface 45.

Referring to FIGS. 2-5 again, the terminal holder assembly 10 is received in the receiving groove 44. The terminal holder assembly 10 has two opposite short side walls 13 disposed at two opposite sides of the terminal holder assembly 10. Two holding slots 14 are recessed inward in two middles of two outer surfaces of the two short side walls 13. Each side of a bottom surface of the terminal holder assembly 10 has a first protruding block 112 and a second protruding block 122. Each side of a bottom surface of the first insulating holder 11 protrudes downward to form the first protruding block 112. Each side of a bottom surface of the second insulating holder 12 protrudes downward to form the second protruding block 122.

When terminal assembly 100 is assembled in the receiving groove 44, the two arm portions 481 of the locking portions 48 of the two concave surfaces 46 of the two inner surfaces 45 are received in the two holding slots 14, and the two hooking portions 482 of the locking portions 48 of the two concave surfaces 46 of the two inner surfaces 45 hook the bottom surface of the terminal holder assembly 10. Each hooking portion 482 is limited between the first protruding block 112 and the second protruding block 122 of one side of the bottom surface of the terminal holder assembly 10. The inner surface of the first insulating holder 11 and the inner surface of the second insulating holder 12 have two positioning structures 123. In the preferred embodiment, one positioning structure 123 includes a convex portion 101 protruded from the inner surface of the first insulating holder 11 and a notch 102 recessed into the inner surface of the second insulating holder 12. The other positioning structure 123 includes the convex portion 101 protruded from the inner surface of the second insulating holder 12 and the notch 102 recessed into the inner surface of the first insulating holder 11. The convex portion 101 is matched with the notch 102.

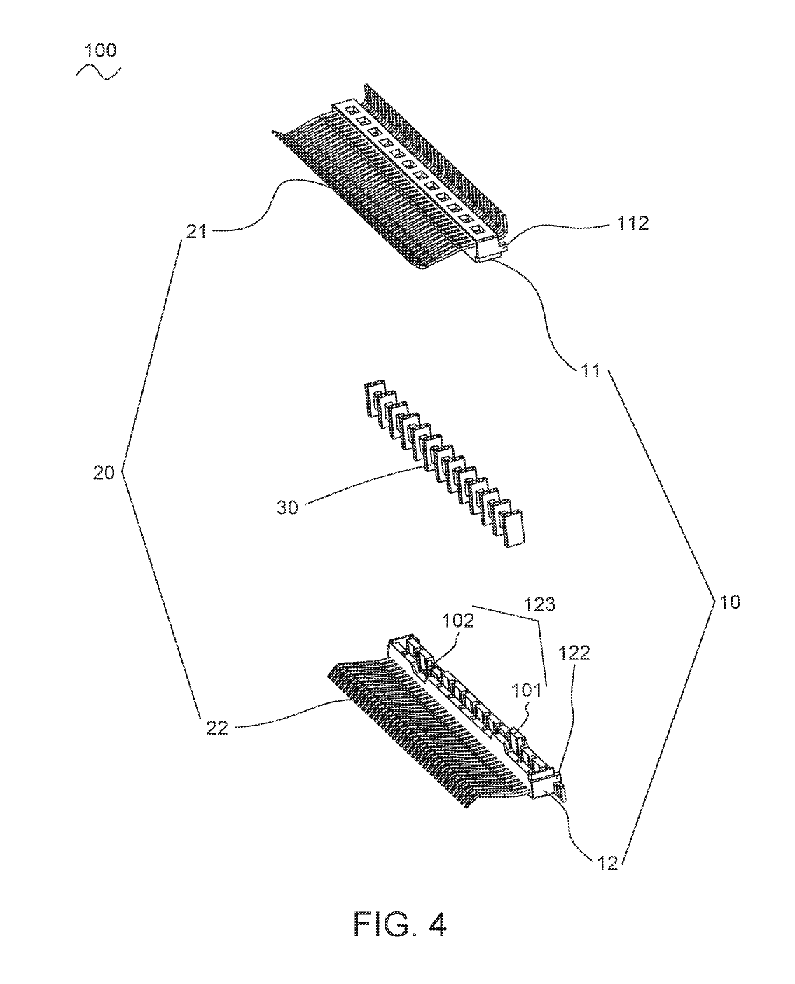

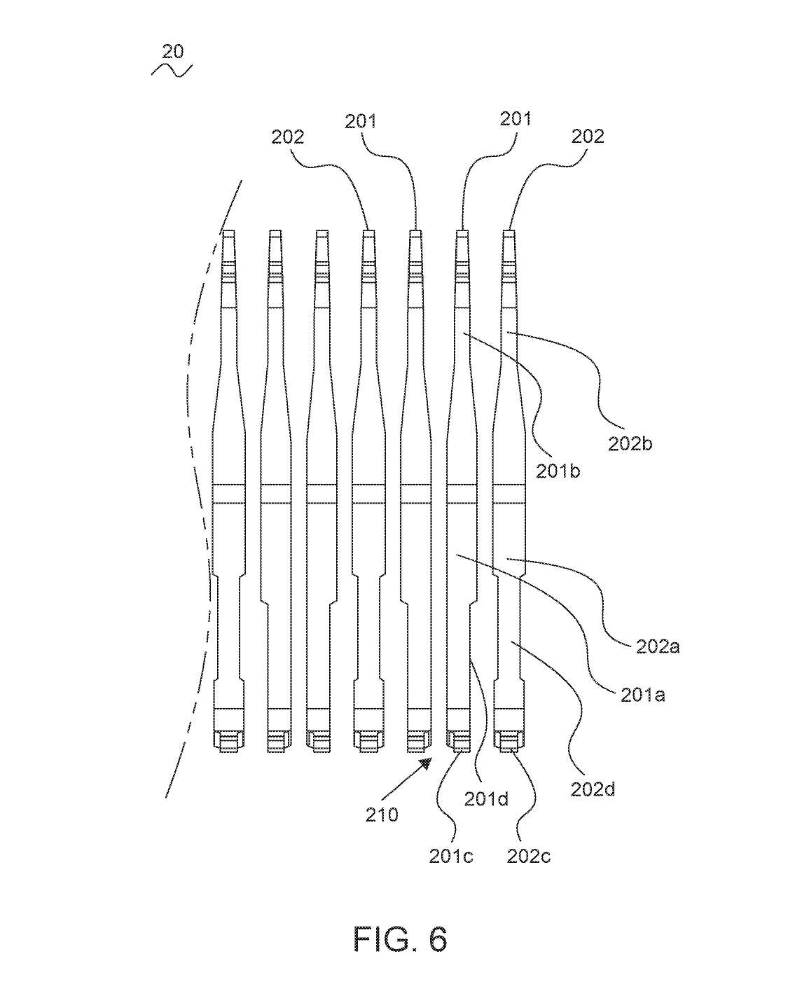

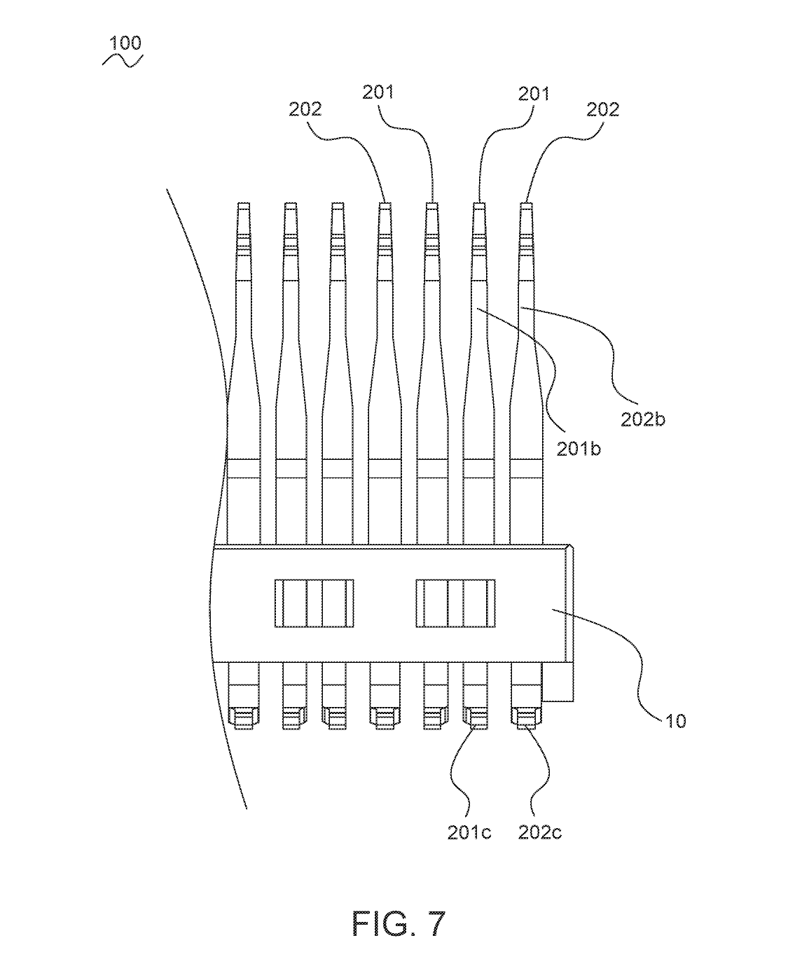

Referring to FIGS. 4, 6, and 7, the terminal module 20 includes a plurality of grounding terminals 202, and a plurality of signal terminals 201 disposed among the plurality of the grounding terminals 202. The first terminal module 21 includes the plurality of the signal terminals 201 and the plurality of the grounding terminals 202. The second terminal module 22 includes the plurality of the signal terminals 201 and the plurality of the grounding terminals 202. The plurality of the signal terminals 201 and the plurality of the grounding terminals 202 are disposed at regular intervals. Each two adjacent signal terminals 201 form a differential terminal pair 210. The differential terminal pair 210 is located between two grounding terminals 202. Each two adjacent signal terminals 201 are located between the two grounding terminals 202.

Referring to FIGS. 1-7, each of the plurality of the signal terminals 201 and the grounding terminals 202 is shown as an elongated shape. Each signal terminal 201 has a fastening portion 201a. Each grounding terminal 202 has a fixing portion 202a. A top end of the fastening portion 201a extends upward to form a contacting portion 201b. A top end of the fixing portion 202a extends upward to form a touching portion 202b. Specifically, the top end of the fastening portion 201a slantwise extends upward and inward, and is further arched inward to form the contacting portion 201b. The top end of the fixing portion 202a slantwise extends upward and inward, and is further arched inward to form the touching portion 202b. A bottom end of the fastening portion 201a is bent outward to form a soldering portion 201c. A bottom end of the fixing portion 202a is bent outward to form a soldering bar 202c.

The fastening portion 201a is fastened in the terminal holder assembly 10, and the fastening portion 201a is surrounded by the terminal holder assembly 10. The fixing portion 202a is fixed in the terminal holder assembly 10, and the fixing portion 202a is surrounded by the terminal holder assembly 10. The fastening portions 201a of the plurality of the signal terminals 201 are fastened in the first insulating holder 11 and the second insulating holder 12, and the fastening portions 201a of the plurality of the signal terminals 201 are surrounded by the first insulating holder 11 and the second insulating holder 12. The fixing portions 202a of the plurality of the grounding terminals 202 are fastened in the first insulating holder 11 and the second insulating holder 12, and the fixing portions 202a of the plurality of the grounding terminals 202 are surrounded by the first insulating holder 11 and the second insulating holder 12.

A substantial middle of the contacting portion 201b is arched inward, two sides of a bottom end of the contacting portion 201b are gradually inclined inward and upward, and two sides of a top end of the contacting portion 201b are further inclined inward and upward. The contacting portion 201b tapers from bottom to top. A substantial middle of the touching portion 202b is arched inward, two sides of a bottom end of the touching portion 202b are gradually inclined inward and upward, and two sides of a top end of the touching portion 202b are further inclined inward and upward. The touching portion 202b tapers from bottom to top. A width of the top end of the contacting portion 201b is one third of a width of the bottom end of the contacting portion 201b which extends out of the terminal holder assembly 10, so that a section area of each signal terminal 201 and a section area of each grounding terminal 202 are reduced, and an impedance of each signal terminal 201 and an impedance of each grounding terminal 202 are decreased. In that case, a high-frequency performance of the electrical connector 200 is improved.

One side of the fastening portion 201a of each signal terminal 201 which is adjacent to the fixing portion 202a of one grounding terminal 202 is recessed inward to form a lacking groove 201d. A position of the fixing portion 202a of each grounding terminal 202 which is corresponding to the lacking groove 201d of one signal terminal 201 forms a narrowing portion 202d. Two opposite sides of the narrowing portion 202d are recessed inward. The lacking groove 201d is corresponding to the narrowing portion 202d, and the lacking groove 201d faces the narrowing portion 202d, so the section area of the fastening portion 201a of each signal terminal 201 and the section area of the fixing portion 202a of each grounding terminal 202 are reduced, an impedance matching performance of the electrical connector 200 is improved, and a working stability of the electrical connector 200 under a high-frequency environment is improved.

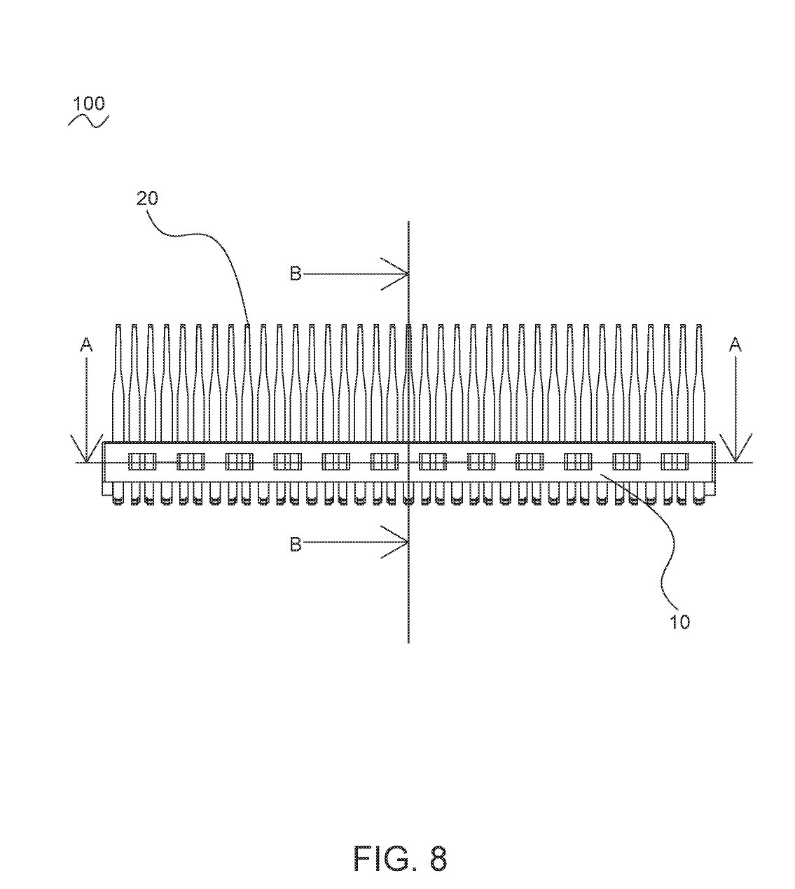

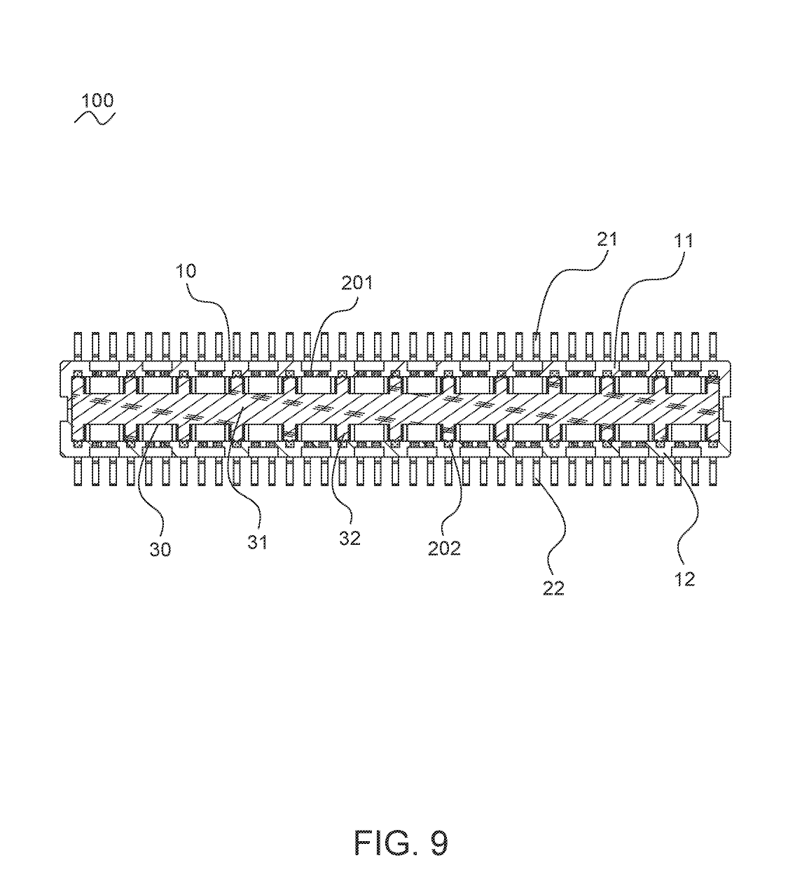

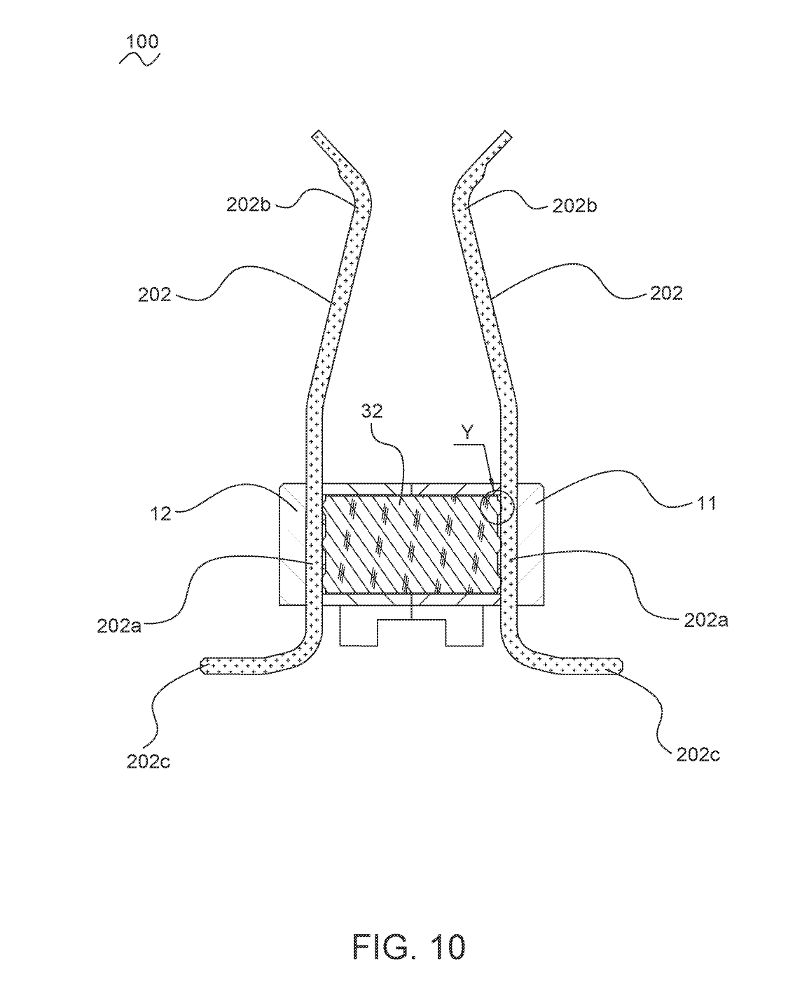

Referring to FIGS. 4-10, the conductive connecting element 30 is completely surrounded by the terminal holder assembly 10. The conductive connecting element 30 is electrically connected between the first terminal module 21 and the second terminal module 22. The conductive connecting element 30 is made of a conductive plastic material. The conductive connecting element 30 has a main portion 31, and a plurality of connecting blocks 32 longitudinally protruded outward from the main portion 31. The main portion 31 is shown as a lathy shape. The main portion 31 is clamped between the first insulating holder 11 and the second insulating holder 12. The plurality of the connecting blocks 32 are continuously disposed along the main portion 31. The plurality of the connecting blocks 32 are arranged at fixed intervals. The plurality of the connecting blocks 32 are extended outward, and the plurality of the connecting blocks 32 are electrically connected with the plurality of the grounding terminals 202 of the first terminal module 21 and the second terminal module 22.

In the preferred embodiment, the plurality of the grounding terminals 202 of the first terminal module 21 and the plurality of the grounding terminals 202 of the second terminal module 22 are symmetrically disposed along a longitudinal direction. The plurality of the connecting blocks 32 extend longitudinally, and the plurality of the connecting blocks 32 are electrically connected with the grounding terminals 202 of the first terminal module 21 and the second terminal module 22. A gap between two middle lines of each two adjacent connecting blocks 32 is equal to a gap between two middle lines of each two adjacent grounding terminals 202 of each of the first terminal module 21 and the second terminal module 22. The plurality of the grounding terminals 202 of the first terminal module 21 and the second terminal module 22 are mutually conductive by the conductive connecting element 30, and the plurality of the grounding terminals 202 of the first terminal module 21 and the second terminal module 22 have the same potential.

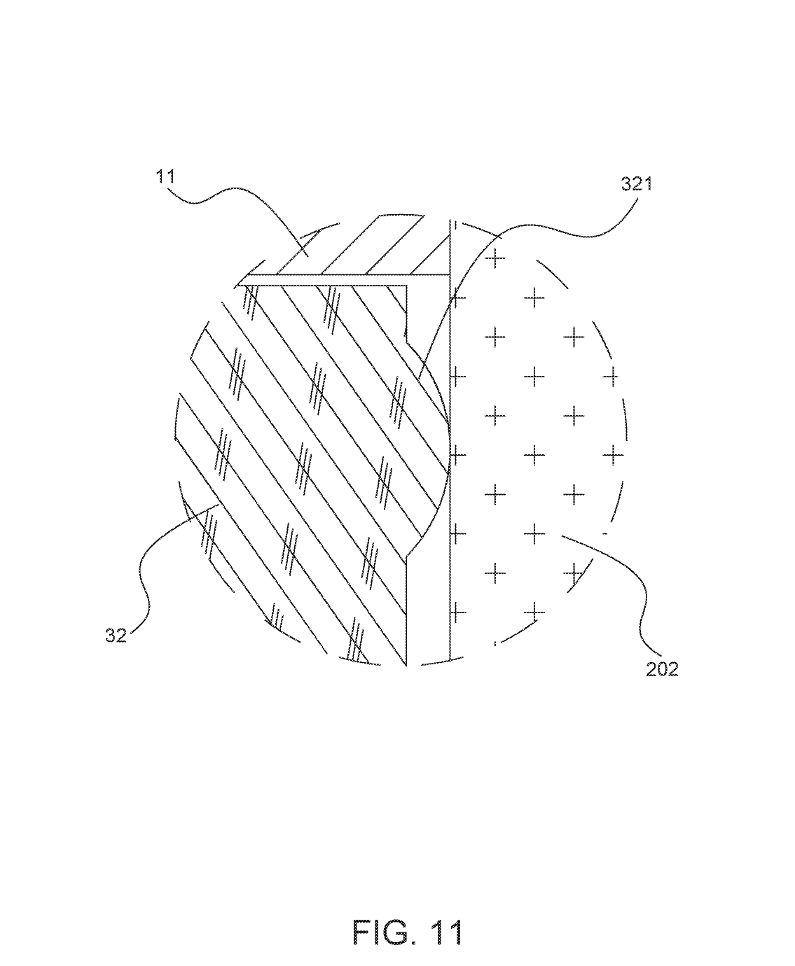

Referring to FIGS. 1-11, in order to avoid a clearance forming between each grounding terminal 202 and one connecting block 32 at the time of each grounding terminal 202 bending. Each connecting block 32 has two opposite outer surfaces facing towards two grounding terminals 202. Each outer surface of each connecting block 32 protrudes outward to form at least one protruding point 321. The at least one protruding point 321 is electrically connected with the narrowing portion 202d of the one grounding terminal 202. Several portions of a connecting area of each connecting block 32 which is connected with the one grounding terminal 202 protrude outward to form three protruding points 321. A protruding degree of each protruding point 321 is adjusted easily when each protruding point 321 is manufactured.

The plurality of the connecting blocks 32 contact with the plurality of the grounding terminals 202 of the first terminal module 21 and the second terminal module 22, and the plurality of the connecting blocks 32 are reliably connected with the plurality of the grounding terminals 202 of the first terminal module 21 and the second terminal module 22. The main portion 31 of the conductive connecting element 30 is separated from the differential terminal pair 210, and the main portion 31 of the conductive connecting element 30 keeps a distance from the differential terminal pair 210. In the preferred embodiment, the protruding points 321 of the plurality of the connecting blocks 32 abut against the narrowing portions 202d of the fixing portions 202a of the plurality of the grounding terminals 202 of the first terminal module 21 and the second terminal module 22. The conductive connecting element 30 is electrically connected with the fixing portion 202a of each grounding terminal 202.

As described above, the conductive connecting element 30 is electrically connected with the plurality of the grounding terminals 202 of the first terminal module 21 and the second terminal module 22, so a potential difference among the plurality of the grounding terminals 202 of the first terminal module 21 and the second terminal module 22 is eliminated, a resonance point of a crosstalk is pushed to a high frequency. Furthermore, the contacting portions 201b of the plurality of the signal terminals 201 and the touching portions 202b of the plurality of the grounding terminals 202 taper from bottom to top, each signal terminal 201 has the lacking groove 201d, and each grounding terminal 202 has the narrowing portion 202d, the section area of each signal terminal 201 and the section area of each grounding terminal 202 are reduced, and the impedance of each signal terminal 201 and the impedance of each grounding terminal 202 are decreased. As a result, the electrical connector 200 effectively restrains the resonance point of the crosstalk, a crosstalk problem of high-frequency signals is improved, and a transmission capability of the high-frequency signals is improved.

Though the present invention is disclosed as the above-mentioned preferred embodiment, the preferred embodiment disclosed in this invention is without being intended to limit a scope of this invention. In related technical fields, anyone with ordinary knowledges should be able to make a few changes and embellishments within a spirit and a protection scope of this invention, so the protection scope of this invention should regard defined claims of an attached application patent as a standard.

What is claimed is:

1. An electrical connector, comprising:
a first insulating holder shown as a narrow rectangular shape;
a first terminal module penetrating through the first insulating holder along an up-down direction, the first terminal module including a plurality of signal terminals and a plurality of grounding terminals, each two adjacent signal terminals being located between two grounding terminals;
a second insulating holder shown as the narrow rectangular shape, the second insulating holder being matched with the first insulating holder, the second insulating holder being combined with the first insulating holder;
a second terminal module penetrating through the second insulating holder along the up-down direction, the second terminal module including the plurality of the signal terminals and the plurality of the grounding terminals, the plurality of the grounding terminals of the first terminal module and the plurality of the grounding terminals of the second terminal module being symmetrically disposed along a longitudinal direction; and
a conductive connecting element fully surrounded between the first insulating holder and the second insulating holder, the conductive connecting element being electrically connected between the first terminal module and the second terminal module, the conductive connecting element having a main portion, and a plurality of connecting blocks longitudinally protruded outward from the main portion, the main portion being shown as a lathy shape, the main portion being clamped between the first insulating holder and the second insulating holder, the plurality of the connecting blocks being continuously disposed along the main portion, the plurality of the connecting blocks being arranged at fixed intervals, the plurality of the connecting blocks being extended outward, and the plurality of the connecting blocks being electrically connected with the plurality of the grounding terminals of the first terminal module and the second terminal module.

2. The electrical connector as claimed in claim 1 wherein each signal terminal has a fastening portion, each grounding terminal has a fixing portion, the fastening portions of the plurality of the signal terminals are fastened in the first insulating holder and the second insulating holder, and the fastening portions of the plurality of the signal terminals are surrounded by the first insulating holder and the second insulating holder, the fixing portions of the plurality of the grounding terminals are fastened in the first insulating holder and the second insulating holder, and the fixing portions of the plurality of the grounding terminals are surrounded by the first insulating holder and the second insulating holder.

3. The electrical connector as claimed in claim 2 wherein a top end of the fastening portion extends upward to form a contacting portion, a top end of the fixing portion extends upward to form a touching portion, one side of the fastening portion of each signal terminal which is adjacent to the fixing portion of one grounding terminal is recessed inward to form a lacking groove, a position of the fixing portion of each grounding terminal which is corresponding to the lacking groove of one signal terminal forms a narrowing portion, two opposite sides of the narrowing portion are recessed inward, the lacking groove is corresponding to the narrowing portion, and the lacking groove faces the narrowing portion.

4. The electrical connector as claimed in claim 1 wherein several portions of a connecting area of each connecting block which is connected with one grounding terminal protrude outward to form three protruding points, the protruding points of the plurality of the connecting blocks abut against the narrowing portions of the fixing portions of the plurality of the grounding terminals of the first terminal module and the second terminal module.

5. The electrical connector as claimed in claim 2 wherein a top end of the fastening portion slantwise extends upward and inward, and is further arched inward to form a contacting portion, a top end of the fixing portion slantwise extends upward and inward, and is further arched inward to form a touching portion, a bottom end of the fastening portion is bent outward to form a soldering portion, a bottom end of the fixing portion is bent outward to form a soldering bar.

6. The electrical connector as claimed in claim 5 wherein a substantial middle of the contacting portion is arched inward, two sides of a bottom end of the contacting portion are gradually inclined inward and upward, and two sides of a top end of the contacting portion are further inclined inward and upward, the contacting portion tapers from bottom to top, a substantial middle of the touching portion is arched inward, two sides of a bottom end of the touching portion are gradually inclined inward and upward, and two sides of a top end of the touching portion are further inclined inward and upward, the touching portion tapers from bottom to top.

7. The electrical connector as claimed in claim 1 wherein a gap between two middle lines of each two adjacent connecting blocks is equal to a gap between two middle lines of each two adjacent grounding terminals of each of the first terminal module and the second terminal module.

8. The electrical connector as claimed in claim 1 wherein a middle of an inner surface of the first insulating holder is recessed inward to form a first recess, and a middle of an inner surface of the second insulating holder is recessed inward to form a second recess, the inner surface of the first insulating holder is combined with the inner surface of the second insulating holder, so the first recess is combined with the second recess to define a fastening space, the conductive connecting element is disposed in the fastening space, the conductive connecting element is fastened in the fastening space.

9. The electrical connector as claimed in claim 1 wherein the conductive connecting element is made of a conductive plastic material.

10. An electrical connector, comprising:
a shell;
an insulating body disposed in the shell;
a terminal holder assembly fastened in the insulating body;
a terminal module fastened in the terminal holder assembly, the terminal module including a plurality of grounding terminals, and a plurality of signal terminals disposed among the plurality of the grounding terminals, each signal terminal having a fastening portion fastened in the terminal holder assembly, each grounding terminal having a fixing portion fixed in the terminal holder assembly, a top end of the fastening portion extending upward to form a contacting portion, a top end of the fixing portion extending upward to form a touching portion, a bottom end of the fastening portion being bent outward to form a soldering portion, a bottom end of the fixing portion being bent outward to form a soldering bar, one side of the fastening portion of each signal terminal which is adjacent to the fixing portion of one grounding terminal being recessed inward to form a lacking groove, a position of the fixing portion of each grounding terminal which is corresponding to the lacking groove of one signal terminal forming a narrowing portion, two opposite sides of the narrowing portion being recessed inward; and
a conductive connecting element completely surrounded by the terminal holder assembly, the conductive connecting element having a main portion, and a plurality of connecting blocks longitudinally protruded outward from the main portion, each connecting block having two opposite outer surfaces facing towards two grounding terminals, each outer surface of each connecting block protruding outward to form at least one protruding point, the at least one protruding point being electrically connected with the narrowing portion of the one grounding terminal.

11. An electrical connector, comprising:
a shell;
an insulating body disposed in the shell, the insulating body having:
a receiving groove formed inside the insulating body and penetrating through a bottom of the insulating body;
two inner surfaces disposed to two opposite sides of the receiving groove;
two base portions protruded inward from the two inner surfaces;
two arm portions extended downward from bottom surfaces of the two base portions;
two hooking portions protruded inward from two bottom ends of the two arm portions; and
two avoiding spaces, each avoiding space being formed between one arm portion and one inner surface;
a terminal holder assembly received in the receiving groove, the terminal holder assembly having:
two short side walls disposed at two opposite sides of the terminal holder assembly; and
two holding slots recessed inward in two middles of two outer surfaces of the two short side walls;
a terminal module fastened in the terminal holder assembly, the terminal module including a plurality of grounding terminals, and a plurality of signal terminals disposed among the plurality of the grounding terminals, each signal terminal having a fastening portion fastened in the terminal holder assembly, each grounding terminal having a fixing portion fixed in the terminal holder assembly, a top end of the fastening portion extending upward to form a contacting portion, a top end of the fixing portion extending upward to form a touching portion, a bottom end of the fastening portion being bent outward to form a soldering portion, a bottom end of the fixing portion being bent outward to form a soldering bar; and
a conductive connecting element disposed in the terminal holder assembly, the conductive connecting element being electrically connected with the fixing portion of each grounding terminal;
wherein the two arm portions are received in the two holding slots, the two hooking portions hook a bottom surface of the terminal holder assembly.

12. The electrical connector as claimed in claim 11 wherein each side of the bottom surface of the terminal holder assembly has a first protruding block and a second protruding block arranged longitudinally, each hooking portion is limited between the first protruding block and the second protruding block of one side of the bottom surface of the terminal holder assembly.

13. The electrical connector as claimed in claim 12 wherein a middle of each inner surface is recessed outward to form a concave surface, a top of the concave surface protrudes inward to form the base portion, the base portion extends out of the concave surface, the concave surface of each inner surface is spaced from the one arm portion to form the avoiding space between the concave surface of each inner surface and the one arm portion.
